(19) United States
(12) Patent Application Publication
(10) Pub. No.: US 2012/0253970 A1
(43) Pub. Date: Oct. 4, 2012

(54) SYSTEM AND METHOD FOR SHARING GAINS TO PROMOTE SALES THROUGH EVALUATION CONTENTS OF GOODS ON WEB SITE

(75) Inventors: Young Bae KU, Seoul (KR); Jung Du Choi, Seoul (KR)

(73) Assignee: GMARKET Inc., Seoul (KR)

(21) Appl. No.: 13/359,829

(22) Filed: Jan. 27, 2012

Related U.S. Application Data
(63) Continuation of application No. 11/995,068, filed on Jun. 12, 2008, now abandoned.

(30) Foreign Application Priority Data
Jul. 8, 2005 (KR) 10-2005-0061899

(51) Int. Cl. G06Q 30/06

(52) U.S. Cl. 705/26.7

(57) ABSTRACT

The present invention provides a system and method for sharing profits with beneficiaries designated by a recommender who evaluates goods of an on-line shopping mall or an on-line portal site etc. (hereinafter, an e-trading system), when a purchaser connects to the e-trading platform and buys goods of the e-trading platform through the evaluation contents. The system includes a web server for administrating general purchasing procedures and performing other functions, an information providing arrangement for providing access to information on the goods including a beneficiary identifying code by connecting to the sales web page of the e-trading platform, and a profit sharing server for distributing the profit to the designated beneficiary, when any purchaser buys the goods or services at the web page of the e-trading platform including the beneficiary identifying codes through the recommendation contents.

### CROSS-REFERENCE TO RELATED APPLICATIONS

This is a continuation of U.S. application Ser. No. 11/995,068, filed Jun. 12, 2008 (now abandoned), which was the National Stage of International Application number PCT/KR2006/002567, filed on Jun. 30, 2006. The present continuation application also claims the benefit of priority of Korean application number 10-2005-0061899, filed Jul. 8, 2005. The disclosures of these earlier applications are incorporated herein by reference.

### TECHNICAL FIELD

The present invention relates to a system and method for sharing profits to promote sales through a recommendation or evaluation contents on a web site, more particularly a system and method for sharing profits with beneficiaries designated by a recommender who evaluates goods of an on-line shopping mall or an on-line portal site etc. (hereinafter, an e-trading system), when a purchaser connects to the e-trading platform and buys goods of the e-trading platform through the evaluation contents.

### BACKGROUND ART

Most of web sites provide their members with the newsletter etc. including contents or information on commercial goods, and therefore the members are induced to visit these web sites more frequently. Also, the web logs provide private interesting subjects including contents or information on commercial goods or restaurants, and therefore the web surfers are induced to visit these web logs more frequently.

As internet is widely spread, internet surfers are being exposed on an enormous amount of information on news, goods or services etc. In the meantime, since there are a number of e-market places, portal sites, B to B or B to C web sites installed on the internet as an example of e-trading platform, a number of merchants or e-dealers, who sell goods or services through the e-trading platform, should advertise their services by paying their own cost. Usually, in this case, dealers share the profits originated from sales of the goods or services with web site operators and the customer only obtain purchase reserving points which can be used to purchase other goods or contents in the e-trading platform. However, a recommender or a evaluator, e.g. the web log operators, the newsletter operator who have experienced the purchase of the goods or services at the specific e-trading platform, don't get any rewards from the dealers or the e-trading platform operators and therefore they don't have the will to update their contents any more actively.

Therefore, as a number of e-market places, portal sites, B to B or B to C web sites are increased, a number of merchants or e-dealers can't increase any more amount of sales and profits through the marketing strategy based on the on-line banner or off-line advertisement. It is necessary to share the profits between the recommender, the e-trading platform operator and the customer.

### SUMMARY OF THE INVENTION

The present invention provides a system and method for sharing profits with beneficiaries designated by a recommender who evaluates goods of an e-trading system, when a purchaser connects to the e-trading platform and buys goods of the e-trading platform through the evaluation contents.

In an embodiment, the present invention provides a system for sharing profits of the goods sales comprising: a web server for administrating general purchasing procedures of registration, search, order, refund and delivery confirmation for goods, registering recommendation contents written by a recommender, a beneficiary, a profit sharing rate and a recommended goods list, and showing a sales web page of an e-trading platform; information providing means for providing the linking means with information on the goods including a beneficiary identifying code by connecting to the sales web page of the e-trading platform; and a profit sharing server for distributing the profit to the designated beneficiary, when any purchaser buys the goods or services at the web page of the e-trading platform including the beneficiary identifying codes through the recommendation contents.

In another embodiment, the present invention provides a method for sharing profits of the goods sales through a system for administrating general purchasing procedures of registration, search, order, refund and delivery confirmation for goods and showing a sales web page of an e-trading platform comprising steps of: registering recommendation contents written by a recommender, a beneficiary, a profit sharing rate and a recommended goods list; connecting the recommendation contents to the sales web page of the e-trading platform including a beneficiary identifying code; providing purchasing procedures of the goods, when any purchaser wishes to buy the goods at the web page of the e-trading platform including the beneficiary identifying codes through the recommendation contents; and distributing the profit to the designated beneficiary, when the goods is sold through the purchasing procedures.

Also, the present invention provides a computer recordable media for accomplishing the above-mentioned method for sharing profits of the goods sales.

### ADVANTAGE OF THE PRESENT INVENTION

The profit sharing system and method according to the present invention can provide that the operator of the e-trading platform has a plurality of sales network and maximize the promotion the e-trading platform without further effort, so that the e-platform is activated. Also, the recommender gets any rewards from the dealers or gives the beneficiary designated by him/her the profit of the sales, so that the recommender wishes to update their contents more actively.

### BRIEF DESCRIPTION OF THE DRAWINGS

The above and other features, objects and advantages of the present invention will be better understood from the following detailed description of the invention when read in conjunction with the accompanying drawings in which:

FIG. 1 is a schematic view of a system for sharing profits with a recommender and a purchaser according to an embodiment of the present invention;

FIG. 2 is a flow chart of a method for sharing profits with a recommender and a purchaser according to an embodiment of the present invention;

FIG. 3 is a flow chart for showing recommender registration procedures in FIG. 2;

FIG. 4 is a web page for registering recommendation contents to connect the recommendation contents with specific recommended goods;

FIG. 5 is an exemplary image view for showing a web page including a recommendation contents.

### DETAILED DESCRIPTION OF THE EMBODIMENTS

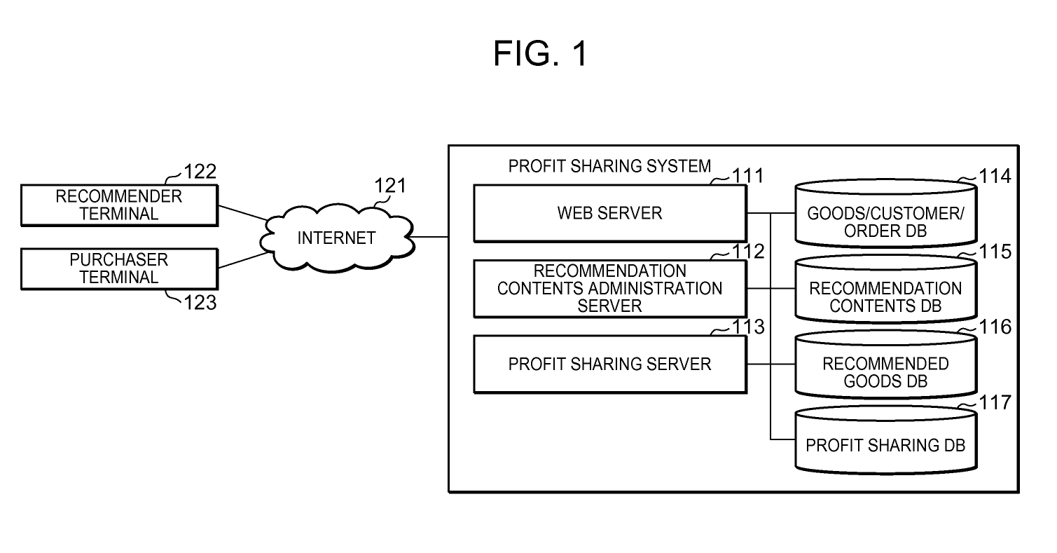

FIG. 1 is a schematic view of a system for sharing profits with a recommender and a purchaser according to an embodiment of the present invention. As shown in FIG. 1, the profit sharing system comprises a web server 111, a contents administration server 112, a profit sharing server 113, a goods/customer/order database 114, a recommendation contents database 115, a recommended goods database 116, a profit sharing database 117. This system is connected to a plurality of recommender terminal 122, a plurality of purchaser terminal 123 through Internet 121. However, for ease of understanding and clarity, the following description may refer to one terminal. As used herein “purchaser” may include not only a customer who searches and finds out the information for goods or services or a purchaser who wishes to buy or bought goods or services, but also a dealer in Business to Business. In FIG. 1, each of recommender terminals 122 and purchaser terminals 123 actually has a plurality of terminals.

The web server 111 usually operates an e-commerce web site, in which a plurality of dealers sell a variety of goods or services and a plurality of customers buy these goods or services. The web server 111 provides purchasing procedures of registration, search, order, refund, and delivery confirmation for these goods or services, sends hypertext markup language (HTML) message showing additional information on goods/customer/order etc., and stores necessary information on the goods/customer/order database 115 to handle the purchasing procedures. Also, the web server 111 can provide a web page including information on the recommender and beneficiary identifying codes.

The recommender, who wishes to introduce the goods or services on the web pages of the web server, apply for registration of the recommendation contents and select the beneficiaries. The recommender can select themselves, other persons, or an organization as the beneficiaries and should set sharing rates of the beneficiaries. When the recommender doesn't set the sharing rates, the sharing rates of each beneficiary are equal. It takes a part in the collection of contributions to set the organization as the beneficiary.

The contents administration server 112 administrates the recommendation contents database 115 and the recommended goods database 116, thereby shows the recommendation contents and the recommended goods list to the customer visiting the e-trading platform. In this case, the recommendation contents can be categorized into a directory of each recommendation field (e.g. home appliance, medical, sports etc.) or a directory of each recommender eligibility (e.g. a purchaser, a specialist, a specialized company etc.).

For example, when a medical specialist specialized in atopy makes the recommendation contents, the recommendation field is categorized into medical and recommender eligibility is categorized into the specialist. Also, since the recommendation contents include the recommended goods list, the recommendation contents related to the atopy may include atopy related goods.

When any purchaser buys the goods or services at the web page of the e-trading platform including the beneficiary identifying codes through the recommendation contents, the profit sharing server 113 distributes the profit to the designated beneficiaries.

The price of goods is determined by a manufacturing cost, a marketing or advertisement cost, a cash back cost, and a dealer's net profit. Accordingly, when the goods are sold without marketing or advertisement, the dealer's profit includes not only the cash back and the dealer's net profit but also the marketing cost.

When the purchaser is the same person as the recommender, that is, the purchaser buys the goods through his/her web log or news letter (or the purchaser buys the goods at the e-trading platform directly), it is considered that the dealer pays an extra marketing cost to sell the goods and therefore the purchaser only get the cash back cost.

When the purchaser is not the same person as the recommender, that is, the purchaser buys the goods through recommender's web log or news letter, the purchaser receives a little more cash back or buys the goods at more discounted prices, so that RSS services and the news letter services can be activated.

Also, the purchaser may share the cash back allotted to himself/herself with the beneficiaries designated by him/her. When a plurality of beneficiaries is designated, the profit is distributed in proportion to the designated sharing rates. The types of profit sharing may be a spontaneously discount, point reserving, or the cash back. Necessary information for the profit sharing accomplished by the profit sharing server 113 is stored in the profit sharing database 117.

The goods/client/order database 114 includes information on the goods, information on the dealer, information on the customer, especially information on the purchaser and the order of the goods.

The information on the goods includes at least one of administration number, brand name, category, type, price, manufacturer, the place of origin, specifications, image file, delivery cost type, delivery fee, the period of no interest payment by installment, coupon, gift, etc. The information on the dealer includes at least one of a dealer's identity, a dealer's name, a wire phone number, a mobile phone number, a facsimile number, whether to issue a tax account, whether to issue a receipt, an introduction of the dealer, a mini shop logo file, a customer evaluation degree, etc. The information on the purchaser includes at least one of a purchaser's identity, a purchaser's name, a birth date, a wire phone number, a mobile phone number, a facsimile number, address, purchasing goods, purchasing date, whether to register an recommender, whether to register beneficiaries, sharing rates, information collecting method, etc. The information on the order includes a shopping cart number, information on a purchaser, a transaction number, a transaction date, information on goods, settlement amount of money, settlement status, delivery fee, settlement method, a bank name, a recipient, a recipient call number, and a delivery address etc.

The recommendation contents database 115 includes at least one of a recommender ID, a recommender serial number, a secret code, recommendation contents, recommender eligibility, a beneficiary, a beneficiary identifying code, sharing rates, a recommendation list etc. and stores a recommender's column, article, manuscript after use etc.

The recommended goods database 116 includes at least one of general information on goods, a recommendation list, a beneficiary, a beneficiary identifying code, sharing rates, classification information, etc.

To distribute the profit by the goods sales, the profit sharing database 117 includes at least one of purchaser's information, recommender's information, beneficiaries and sharing rates, sales date, each profit of beneficiaries, a profit sharing method, etc.

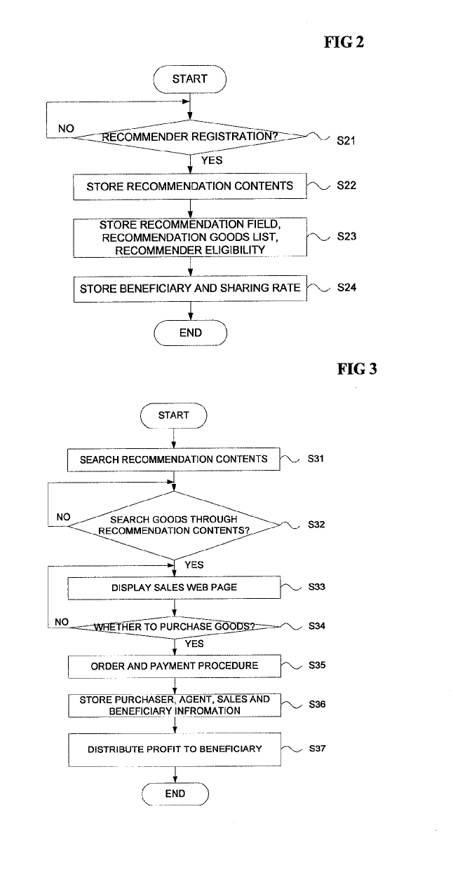

FIG. 2 is a flow chart of a method for sharing profits with a recommender and a purchaser according to an embodiment of the present invention.

The e-trading platform provides usual trading functions and special trading function according to the embodiments of the invention. The specific trading function of this embodiment left out the usual trading functions will be explained as follows. In this embodiment, the web site having the above mentioned functions is defined as the profit sharing web site.

The recommender is defined as any person who has bought specific goods and has registered recommendation contents in the web site of the e-trading platform, or a specialist who makes a recommendation contents as a well informed person in the field.

Any person registers as the recommender of the e-trading platform to promote the goods on the e-trading platform (S21), the web server stores the recommendation contents from the recommender (S22).

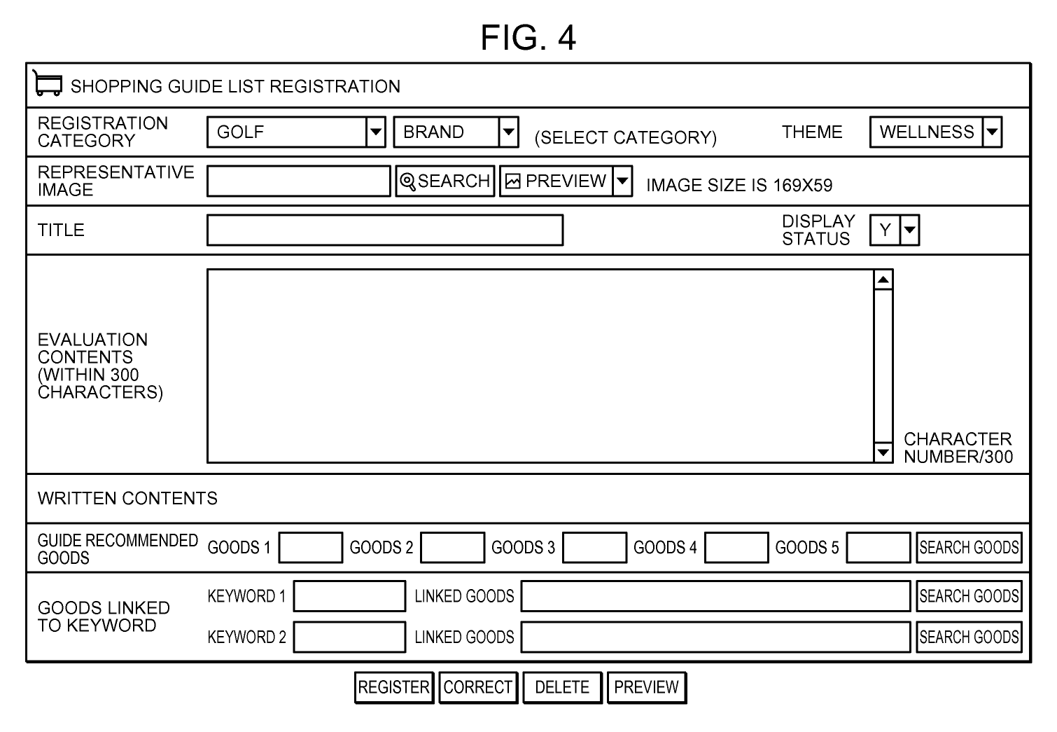

FIG. 4 is a web page for registering recommendation contents to connect the recommendation contents with specific recommended goods. As shown in FIG. 4, when registering the recommendation contents, the web server is inputted to store a registration category, a theme, a representative image, a title, a summary, a recommendation contents, a recommended goods, and keywords, etc.

When any customer visits the e-trading platform and searches the recommendation contents, all recommendation contents linked up to specific recommended goods are displayed, the specific keywords of the recommendation contents linked up to the specific recommended goods are displayed, a tag of the recommended goods linked up to the specific recommended goods are displayed, or the specific phrase or sentence of the recommendation contents linked up to the specific recommended goods are displayed.

When the pointer of mouse is touched on all or any part of the recommendation contents, the image of the goods may be activated and displayed. The image, brand name, and approximate explanation on the goods are shown in a list of the recommended goods. When the image or brand name of the goods is clicked, the customer can connect to the web pages of the specific recommended goods in the e-trading platform. These web pages also display information about other recommenders and all recommendation contents written by them.

When the recommender registers the recommendation contents, the web server induce a log in or a subscription. When any purchaser who has ever bought the goods in the e-trading platform without the subscription wants to register as the recommender, the order number of the purchaser can be used as information about the recommender.

And then the web server is inputted to store the recommendation field, the recommended goods list and the recommender eligibility (S23). The recommendation contents include the specialized knowledge, the manuscript after use, and the recommended goods list eligible for a specific field or general use.

The web server is also inputted to store the beneficiary and the sharing rates thereof (S24). The recommender can select themselves, other persons, or an organization as the beneficiaries and should set sharing rates of the beneficiaries. When the recommender doesn't set the sharing rates, the sharing rates of each beneficiary are equal. It takes a part in the collection of contributions to set the organization as the beneficiary.

FIG. 3 is a flow chart for showing purchasing procedures and profit sharing procedures according to an embodiment of the present invention.

The recommendation contents are categorized according to the directories of the recommendation field and the recommender eligibility etc through the steps of FIG. 2.

Firstly, any customer connects to the web page of the e-trading platform and searches the recommendation contents (S31).

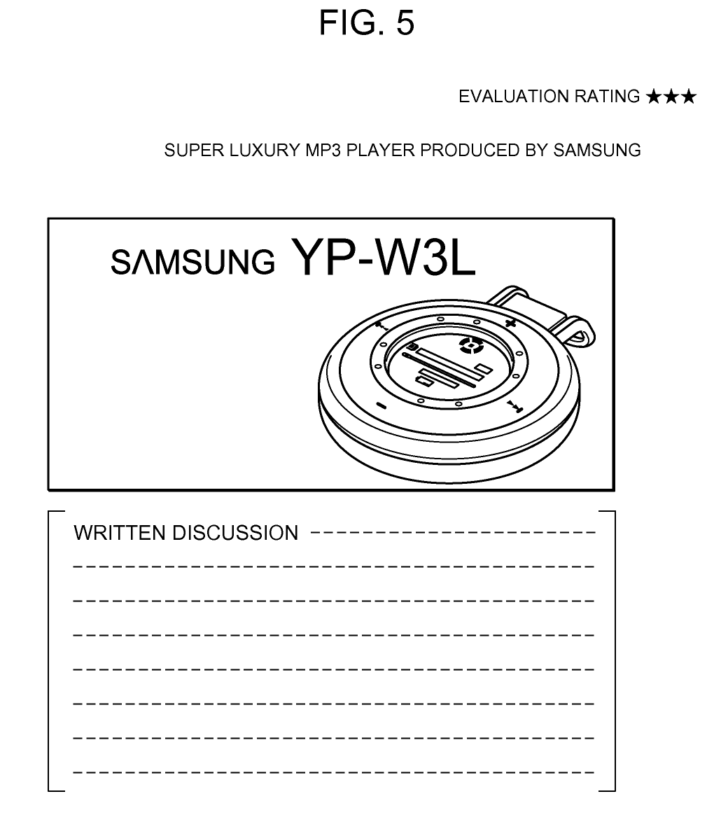

FIG. 5 is an exemplary image view for showing a web page including a recommendation contents. This web page includes a summary and representative image about specific goods, the recommendation contents, and the brand name and brief information of recommended goods at a part of recommendation contents, etc. When all recommendation contents, the keywords, specific phrase or sentence of the recommendation contents are clicked, the sales web page and the detailed information of the specific recommended goods are displayed. When the pointer of mouse is also touched on all or any part of the recommendation contents, the image of the goods may be activated and displayed.

When the customer searches the recommended goods through the recommendation contents (S32), the web server displays the detailed explanation on the recommended goods and the sales web page of the e-trading platform (S33). These sales web pages also include the beneficiary identifying code, information on the recommender.

When the pointer of mouse is touched on the brand name in the recommendation contents, the image of the goods may be activated and displayed. When the pointer of mouse is also touched on the image, brand name or brief explanation of the recommended goods list, the image of the goods may be activated and displayed.

When the customer orders the goods through the recommendation contents and the sales web page (S34), the web server proceeds to the usual order and payment process (S35).

When the purchaser is the same person as the recommender, the web server shows how much the purchaser gets the amount of the profit in comparison with the amount of the profit through other recommender, and gives the purchaser a selection chance for the beneficiary. When the purchaser is not the same person as the recommender, the web server shows how much the purchaser gets the amount of the profit, and gives the purchaser a selection chance for the beneficiary. When the purchaser buys the goods through other recommender, it is preferable that the web server gives the purchaser equal or more amount of the profit to induce the purchaser to buy the goods through other recommender.

When the payment is accomplished, the web server stores information on the purchaser, the recommender, the sales event, and the beneficiary (S36).

When any purchaser buys the goods or services at the web page of the e-trading platform through S31 to S37, the profit sharing server distributes the profit and the cash back to the beneficiaries in proportion to the sharing rates.

The types of profit sharing may be a spontaneously discount, point reserving, a gift or the cash back etc. When the purchaser selects himself as the beneficiary, the price of the goods is spontaneously discounted, on purchasing the goods.

An embodiment of the present invention described above is only for purpose of illustration and not limitation of the present invention. Therefore, it is understood that as far as it is not above the nature of the present invention, the embodiment shown and described above in FIGS. 1 to 5 will be also applied to the internet portal site or the contents providing site.

1-14. (canceled)

15. A system comprising:
a contents administration server to maintain recommendation contents about a particular item of a plurality of items for sale, the recommendation contents being received via a recommender terminal and including an indication of recommender eligibility that indicates a qualification of a recommender related to a portion of the plurality of items for sale; and
a webserver which, upon receipt of a selection of the particular item or the portion of the plurality of items for sale via a purchaser terminal, provides the recommendation contents to a potential purchaser.

16. The system of claim 15, wherein the portion of the plurality of items for sale corresponds to a category assigned to the particular item.

17. The system of claim 15, wherein the qualification is that the recommender is a purchaser, a specialist, or a representative of a specialized company.

18. The system of claim 15, wherein the contents administration server receives the indication of recommender eligibility from the recommender via a graphical user interface.

19. The system of claim 15, wherein the contents administration server assigns the indication of recommender eligibility to the recommender based on stored information about the recommender.

20. The system of claim 15, wherein the contents administration server provides additional recommendation contents about the particular item that are received from additional recommenders and categorizes the recommendation contents and the additional recommendation contents according to a directory of recommender eligibility.

21. The system of claim 15, wherein the recommendation contents further include a list of recommended items that identifies related items within a category assigned to the particular item.

22. The system of claim 15, further comprising a profit sharing server to distribute at least a portion of a profit made if the potential purchaser purchases the particular item to a designated beneficiary based on the potential purchaser having been provided the recommendation contents.

23. The system of claim 22, wherein the designated beneficiary is identified using a beneficiary identifying code included in the recommendation contents.

24. A method comprising:
maintaining recommendation contents about a particular item of a plurality of items for sale, the recommendation contents being received from a recommender and including an indication of recommender eligibility that indicates a qualification of a recommender related to a portion of the plurality of items for sale; and
upon receiving a selection of the particular item or the portion of the plurality of items for sale from a potential purchaser, providing the recommendation contents to the potential purchaser.

25. The method of claim 24, wherein the portion of the plurality of items for sale corresponds to a category assigned to the particular item.

26. The method of claim 24, wherein the qualification is that the recommender is a purchaser, a specialist, or a representative of a specialized company.

27. The method of claim 24, further comprising receiving the indication of recommender eligibility from the recommender via a graphical user interface.

28. The method of claim 24, further comprising assigning the indication of recommender eligibility to the recommender based on stored information about the recommender.

29. The method of claim 24 further comprising providing additional recommendation contents about the particular item that are received from additional recommenders and categorizing the recommendation contents and the additional recommendation contents according to a directory of recommender eligibility.

30. The method of claim 24, wherein the recommendation contents further include a list of recommended items that identifies related items within a category assigned to the particular item.

31. The method of claim 24, further comprising distributing at least a portion of a profit made if the potential purchaser purchases the particular item to a designated beneficiary based on the potential purchaser having been provided the recommendation contents.

32. The method of claim 31, wherein the designated beneficiary is identified using a beneficiary identifying code included in the recommendation contents.

33. A non-transitory machine-readable medium having instructions embodied thereon, the instructions being executable by one or more machines to perform operations comprising:
maintaining recommendation contents about a particular item of a plurality of items for sale, the recommendation contents being received from a recommender and including an indication of recommender eligibility that indicates a qualification of a recommender related to a portion of the plurality of items for sale; and
upon receiving a selection of the particular item or the portion of the plurality of items for sale from a potential purchaser, providing the recommendation contents to the purchaser.

34. The non-transitory machine-readable medium of claim 33, wherein the qualification is that the recommender is a purchaser, a specialist, or a representative of a specialized company.
